(19) United States
(12) Patent Application Publication
(10) Pub. No.: US 2023/0238638 A1
(43) Pub. Date: Jul. 27, 2023

(54) VEHICLE BATTERY PACK CASE AND ITS REPLACEMENT SYSTEM

(71) Applicants: Hyundai Motor Company, Seoul (KR); Kia Corporation, Seoul (KR)

(72) Inventors: Seung Hak LEE, Asan-Si (KR); Won Hae LEE, Seoul (KR); Byung Joo CHUNG, Gunpo-Si (KR); Nam Ho KIM, Gwangmyeong-Si (KR); Min Seok KIM, Seoul (KR)

(73) Assignees: Hyundai Motor Company, Seoul (KR); Kia Corporation, Seoul (KR)

(21) Appl. No.: 17/894,402

(22) Filed: Aug. 24, 2022

(30) Foreign Application Priority Data
Jan. 27, 2022 (KR) 10-2022-0012518

(51) Int. Cl. H01M 50/264; B60K 1/04; H01M 50/249

(52) U.S. Cl. CPC H01M 50/264; B60K 1/04; H01M 50/249; B60K 2001/0455; H01M 2220/20

(57) ABSTRACT

A vehicle battery pack case includes a battery bolt provided on a lateral side of a vehicle frame; a first nut provided outside the battery bolt, externally and internally formed with an internal screw thread and an external screw thread, of which tightening directions are opposite to each other, and tightened to the battery bolt through the internal screw thread; and a second nut provided outside the battery bolt and the first nut, and tightened to the first nut through the external screw thread formed on the first nut.

### CROSS REFERENCE TO RELATED APPLICATION

The present application claims priority to Korean Patent Application No. 10-2022-0012518, filed Jan. 27, 2022, the entire contents of which is incorporated herein for all purposes by this reference.

### BACKGROUND OF THE PRESENT DISCLOSURE

### Field of the Present Disclosure

The present disclosure relates to a battery pack case of a vehicle, and more particularly, to a battery pack case of the vehicle, which employs a coupling structure of a bolt and nut without welding a fastening nut to a vehicle body frame, so that maintenance costs may be reduced by replacing only a nut portion with a new one when a battery bolt and the thread of the nut portion are worn out or damaged, and a defect in the bolt or nut portion may be detected in advance by detecting a tightening torque or the number of turns.

### Description of Related Art

An electric vehicle refers to a vehicle that utilizes electrical energy for a power source, and has been continuously researched, developed and commercialized as eco-friendly transportation means that can replace a vehicle that utilizes fossil fuels.

The electric vehicle receives electric power for driving from a built-in battery. Therefore, a battery that can exhibit the performance of a certain level or higher according to industrial conditions is needed to smoothly utilize the electric vehicle in various industrial and business sites.

Conventionally, a battery pack structure of a vehicle has a problem in that a battery mounting pipe nut is welded to a vehicle body or a chassis frame and it is thus difficult to replace only the battery mounting pipe nut when the battery mounting pipe nut is worn out or damaged due to repeated use.

Accordingly, it is necessary to provide a plurality of nuts and bolts so that only a battery mounting pipe nut may be replaced when the battery mounting pipe nut is worn out or damaged, and to Identify whether there is a defect in the bolt and the nut when the replacement of the vehicle battery pack is automated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery pack case of the vehicle, which employs a coupling structure of a bolt and nut without welding a fastening nut to a vehicle body frame, so that maintenance costs may be reduced by replacing only a nut portion with a new one when a battery bolt and the thread of the nut portion are worn out or damaged, and a defect in the bolt or nut portion may be detected in advance by detecting a tightening torque or the number of turns.

According to an exemplary embodiment of the present disclosure, a vehicle battery pack case includes: a battery bolt provided on a lateral side of a vehicle frame; a first nut provided outside the battery bolt, externally and internally formed with an internal screw thread and an external screw thread, of which tightening directions are opposite to each other, and tightened to the battery bolt through the internal screw thread; and a second nut provided outside the battery bolt and the first nut, and tightened to the first nut through the external screw thread formed on the first nut.

The battery bolt may include a lower end portion vertically supported on the vehicle frame, and fastened to the first nut in upward and downward directions thereof.

The first nut may include an assembly/disassembly groove formed on the bottom portion to fasten or remove the first nut.

The second nut may be fixed in the vehicle frame when the assembly/disassembly groove is used in fastening or removing the first nut.

The internal screw thread of the first nut is one of a right-handed screw or a left-handed screw and the external screw thread of the first nut is another of the right-handed screw or the left-handed screw, and the thread direction is formed to be opposite to each other, an internal side and an external side of the first nut are respectively bolted to the battery bolt and the second nut.

A tightening torque between the first nut and the second nut may be greater than a tightening torque between the battery bolt and the first nut.

The lower end portion of the first nut may be shaped like a flange extending outwards to support the battery bolt.

The second nut may include an external diameter longer than an external diameter of the first nut.

The vehicle battery pack case may further include a defect identifier configured to detect tightening information including a tightening torque and a number of turns when the battery bolt is tightened to the first nut, and identify whether the battery bolt and the first nut are defective based on the detected tightening information.

The defect identifier may identify that the battery bolt or the first nut is defective when it is detected that the tightening torque between the battery bolt and the first nut does not reach a reference tightening torque or the number of turns between the battery bolt and the first nut does not reach a reference number of turns.

The defect identifier may identify that the battery bolt or the first nut is normal when it is detected that the tightening torque between the battery bolt and the first nut reaches a reference tightening torque or the number of turns between the battery bolt and the first nut reaches a reference number of turns.

The defect identifier may identify that the first nut or the second nut is defective as the first nut and the second nut are loosened when it is detected that the tightening torque between the battery bolt and the first nut is decreased before the number of turns reaches a reference number of turns.

The defect identifier may identify the battery bolt or the first nut is defective when the tightening torque between the battery bolt and the first nut exceeds a reference tightening torque as the battery bolt or the internal screw thread of the first nut is worn out or damaged, and the tightening torque between the first nut and the second nut is suddenly decreased as the first nut and the second nut are loosened.

According to the present disclosure, the battery pack case of the vehicle employs a coupling structure of a bolt and nut without welding a fastening nut to a vehicle body frame, so that maintenance costs may be reduced by replacing only a nut portion with a new one when a battery bolt and the thread of the nut portion are worn out or damaged, and a defect in the bolt or nut portion may be detected in advance by detecting a tightening torque or the number of turns.

The effects obtainable from the present disclosure are not limited to those mentioned above, and other effects not mentioned above will be apparent to a person including ordinary knowledge in the art, to which the present disclosure pertains, from the following descriptions.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a cross-sectional view showing a battery pack case of a vehicle according to an exemplary embodiment of the present disclosure.

FIG. 2 is a perspective view showing a first nut and a second nut.

FIG. 3 is a perspective view showing an assembly/disassembly groove formed on the bottom portion of a first nut.

FIG. 4 is a perspective view showing a direction in which a battery bolt is tightened to a first nut and a direction in which the first nut is loosened from a second nut.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Regarding embodiments of the present disclosure included in the exemplary embodiment or application, the specific structural or functional description is merely illustrative for describing the exemplary embodiments of the present disclosure, and embodiments of the present disclosure may be implemented in various forms but not be construed as being limited to the exemplary embodiments set forth in the exemplary embodiment or application.

Because the exemplary embodiments of the present disclosure may be variously modified and have various forms, specific exemplary embodiments will be illustrated in the drawings and described in detail in the exemplary embodiment or application. However, it should be understood that embodiments of the present disclosure are intended not to be limited to the specific embodiments but to cover all modifications, equivalents or alternatives without departing from the spirit and technical scope of the present disclosure.

Unless defined otherwise, all terms used herein including technical or scientific terms have the same meanings as those generally understood by a person having ordinary knowledge in the art to which the present disclosure pertains. The terms such as those defined in generally used dictionaries are construed to have meanings matching that in the context of related technology, and unless clearly defined otherwise, are not construed to be ideally or excessively formal.

Below, the present disclosure will be described in detail by describing embodiments with reference to the accompanying drawings. Like reference numerals in the drawings refer to like numerals.

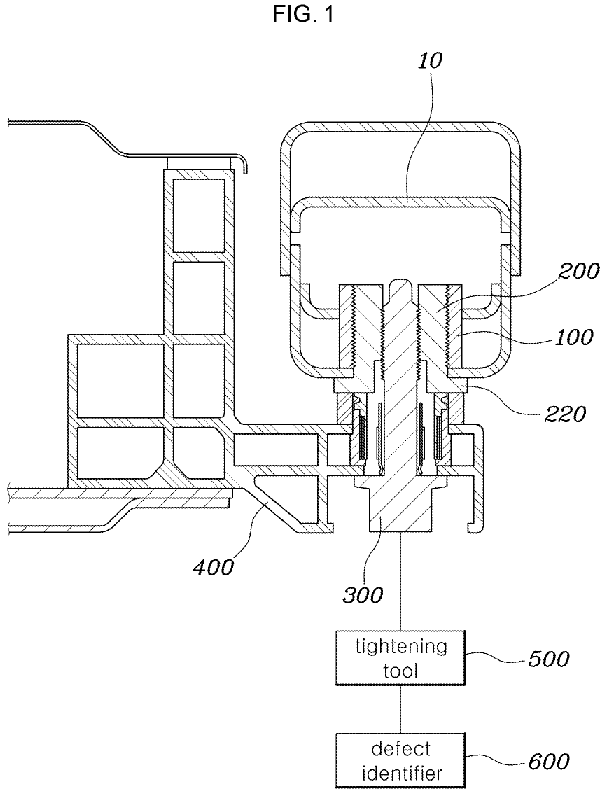

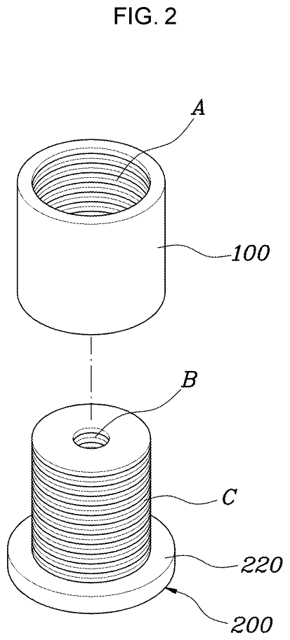

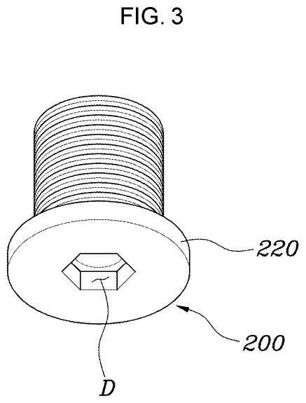

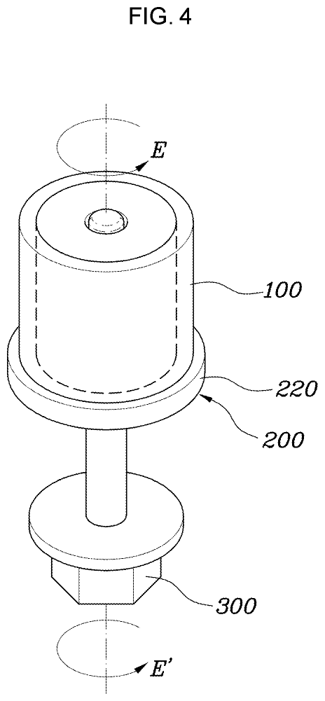

FIG. 1 is a cross-sectional view showing a battery pack case of a vehicle according to an exemplary embodiment of the present disclosure. FIG. 2 is a perspective view showing a first nut and a second nut. FIG. 3 is a perspective view showing an assembly/disassembly groove formed on the bottom portion of a first nut. FIG. 4 is a perspective view showing a direction in which a battery bolt is tightened to a first nut and a direction in which the first nut is loosened from a second nut.

FIG. 1 is a cross-sectional view showing a battery pack case of a vehicle according to an exemplary embodiment of the present disclosure. Referring to FIG. 1, the battery pack case of the vehicle includes a battery bolt 300 provided in a lateral side of a vehicle frame 10; a first nut 200 provided outside the battery bolt 300, externally and internally formed with screw threads (see FIG. 2), i.e., an internal screw thread B and an external screw thread C, of which tightening directions are opposite to each other, and fastened to the battery bolt 300 through the internal screw thread B; and a second nut 100 provided outside the battery bolt 300 and the first nut 100, and fastened to the first nut 200 through the external screw thread C formed on the first nut 200.

According to the present disclosure, not a conventional welding method but a bolting method is used when the battery pack is attached to or detached from the battery pack case of the vehicle, so that a detachable unit that required to be replaced as the battery pack is repeatedly attached and detached may be easily replaced. Furthermore, an identifier for identifying replacement time in advance is provided to facilitate automation related to the battery pack.

Recently, the battery pack of the vehicle has been provided to be replaceable when it is used up. If the battery is replaced in battery replacement facilities instead of being charged, the time taken to charge the battery is saved. Accordingly, such a replacement method has risen.

In the instant case, the battery replacement in the battery replacement facilities is carried out so that a discharged battery pack is replaced with a charged battery pack, and the repeated replacement of the battery pack is unavoidable as long as the vehicle is driven.

Conventionally, a fastening nut is welded to the vehicle frame. Therefore, when the fastening nut is worn out or damaged as the battery pack is repeatedly attached and detached, and not the worn or damaged fastening nut but the whole vehicle frame is replaced. Accordingly, there is a problem with high maintenance costs.

According to the present disclosure, it is proposed to provide a plurality of nuts and bolts so that only a battery mounting pipe nut may be replaced when the battery mounting pipe nut is worn out or damaged, and to identify whether there is a defect in the bolt and the nut when the battery mounting pipe nut is worn out or damaged and the vehicle battery pack is replaced by an automation method.

The battery bolt 300 is provided a lateral side of the vehicle frame 10. Referring to FIG. 1, the lower end portion of the battery bolt 300 is vertically supported on the vehicle frame 10, and fastened to the first nut 200 in upward and downward directions thereof. A plurality of battery bolts 300 are provided at regular intervals in a mounting portion 400, on which a battery pack case is accommodated, of the lateral side of the vehicle frame 10, and thus stably support the battery pack when the battery pack is attached to or detached from the vehicle frame 10.

Furthermore, the lower end portion of the battery bolt 300 is vertically supported on and protrudes upwards from the vehicle frame 10, and coupled to the internal screw thread B of the first nut 200, so that the battery pack may be attached to or detached from the vehicle frame 10 in a vertical direction.

Furthermore, the first nut 200 is provided outside the battery bolt 300, externally and internally formed with the screw threads, i.e., the internal screw thread B and the external screw thread C, of which tightening directions are opposite to each other, and fastened to the battery bolt 300 through the internal screw thread B. With the screw threads externally and internally formed in the first nut 200, a nut may be coupled to the external side of the first nut 200, and a bolt may be coupled to the internal side of the first nut 200, forming a double coupling structure. The lower end portion of the first nut 200 is shaped like a flange 220 extending outwards to support the battery bolt 300, so that the first nut 200 and the second nut 100 may be accommodated on the mounting portion 400 and supported by the battery bolt 300.

FIG. 4 is a perspective view showing a direction E′ in which the battery bolt 300 is tightened to the first nut 200 and a direction E in which the first nut 200 is loosened from the second nut 100. Referring to FIG. 4, the external screw thread C and the internal screw thread B are formed to be different in a tightening direction from each other so that the first nut 200 and the second nut 100 can move in the direction of being fastened to each other when torque is transferred in the direction of loosening the battery bolt 300 due to vibration or the like caused as the vehicle is driven. Therefore, the direction in which the first nut 200 is loosened from the second nut 100 and the direction in which the battery bolt 300 is tightened to the first nut 200 are opposite to each other.

Because the internal screw thread B and the external screw thread C are formed to be tightened in directions opposite to each other, torque is transferred in a direction of tightening the first nut 200 to the second nut 100 when the battery bolt 300 is loosened from the first nut 200, preventing the first nut 200 from being loosened from the second nut 100. Likewise, the first nut 200 is maintained as tightened to the second nut 100 even when the battery bolt 300 is loosened from the first nut 200 to attach or detach the battery pack, securing stability.

As one means to secure the stability, a tightening torque between the first nut 200 and the second nut 100 is set to be greater than a tightening torque between the battery bolt 300 and the first nut 200. To the present end, the external diameter of the second nut 100 may be longer than the external diameter of the first nut 200 so that the tightening torque between the first nut 200 and the second nut 100 may be greater than the tightening torque between the battery bolt 300 and the first nut 200.

For example, the first nut 200 is formed with the internal screw thread B based on a right-handed screw (or a left-handed screw) and the external screw thread C based on the left-handed screw (or the right-handed screw), the tightening directions of which are opposite to each other, the internal side and the external side of the first nut 200 are respectively bolted to the battery bolt 300 and the second nut 100. The second nut 100 is provided outside the battery bolt 300 and the first nut 200, formed with a second nut screw thread A to engage with the external screw thread C formed on the first nut 200, and fastened to the first nut 200.

The first nut 200 couples with the battery bolt 300 through the internal screw thread B formed on the internal side thereof to thereby allow the detachable attachment of the battery pack, and couples with the second nut 100 through the external screw thread C formed on the external side thereof to thereby readily cope with the wear and damage of the first nut 200 caused by the repeated attachment/detachment of the battery pack.

Because the battery bolt 300 and the first nut 200 are repeatedly tightened and loosened as the battery pack is attached and detached, the internal screw thread B may be based on the right-handed screw (or the left-handed screw).

Furthermore, the first nut 200 and the second nut 100 are tightened and loosened when the first nut 200 is worn out or damaged and required to be replaced. Thus, the first nut 200 and the second nut 100 are not often tightened and loosened. Therefore, the external screw thread C is based on the left-handed screw (or the right-handed screw), so that the first nut 200 may be maintained as tightened to the second nut 100 even when the battery back is attached or detached by loosening the battery bolt 300 from the first nut 200.

Furthermore, FIG. 3 is a perspective view showing an assembly/disassembly groove D formed on the bottom portion of the first nut 200. Referring to FIG. 3, the assembly/disassembly groove D is formed on the bottom portion of the first nut 200 to fasten or remove the first nut 200.

The assembly/disassembly groove D provided as shown in FIG. 3 facilitates the replacement of the first nut 200 even though it is difficult to remove the first nut 200 as the first nut 200 is worn out or damaged. Furthermore, the assembly/disassembly groove D makes it easy to fasten a new first nut 200 to the second nut 100 when the first nut 200 is replaced with the new first nut 200. Furthermore, the assembly/disassembly groove D is not limited to a hexagonal shape, but may have various polygonal shapes to fasten or remove the first nut 200.

Furthermore, when the assembly/disassembly groove D is used in fastening or removing the first nut 200, the second nut 100 may be fixed in the vehicle frame 10. When the first nut 200 is required to be replaced as the first nut 200 is worn out or damaged due to the repeated attachment/detachment of the battery pack, the second nut 100 needs to be fixed in the vehicle frame 10 to insert a new first nut 200 in the second nut 100.

When the battery bolt 300 is fastened to the first nut 200, a defect identifier 600 detects tightening information including a tightening torque and the number of turns, and identifies whether there is a defect in the battery bolt 300 and the first nut 200 based on the detected tightening information. The tightening tool 500 may tighten the lower end of the battery bolt 300. And the defect identifier 600 is connected to the tightening tool 500 and can be detected through a sensor of tightening tool 500.

In the instant case, the tightening information is not limited to the tightening torque and the number of turns based on a tightening tool 500 when the battery bolt 300 is tightened to the first nut 200, but may include a tightening angle, a tightening position, etc. based on the tightening tool 500.

The defect identifier 600 identifies that there is a defect in the battery bolt 300 or the first nut 200 when the tightening torque or the number of turns between the battery bolt 300 and the first nut 200 does not reach a reference tightening torque or a reference number of turns.

The reference tightening torque and the reference number of turns for fastening the battery bolt 300 to the first nut 200 are set, and it is identified that there is a problem in fastening the battery bolt 300 to the first nut 200 when the detected tightening torque or the detected the number of turns does not reach the set reference tightening torque or the set reference number of turns. When it is identified that there is a problem in fastening the battery bolt 300 to the first nut 200, it is identified that the battery bolt 300 or the first nut 200 is defective, checking a defect in the battery bolt 300 or the first nut 200.

On the other hand, the defect identifier 600 may identify that the battery bolt 300 and the first nut 200 are normal when the tightening torque and the number of turns between the battery bolt 300 and the first nut 200 reach the reference tightening torque and the reference number of turns.

In the case where the defect identifier 600 identifies that the tightening information is satisfactory as the tightening torque and the number of turns reach the reference tightening torque and the reference number of turns when the battery bolt 300 is tightened to the first nut 200, it is identified that the battery bolt 300 and the first nut 200 are normal, and then the battery is replaced in battery replacement facilities by replacing the battery pack of the vehicle.

Furthermore, the defect identifier 600 may detect a decrease in the tightening torque between the battery bolt 300 and the first nut 200 before reaching the reference number of turns between the battery bolt 300 and the first nut 200.

As described above, the stability of the vehicle frame 10 is secured so that the tightening torque between the first nut 200 and the second nut 100 is set to be greater than the tightening torque between the battery bolt 300 and the first nut 200, and therefore the tightening torque between the first nut 200 and the second nut 100 may be greater than the reference tightening torque between the battery bolt 300 and the first nut 200.

Thus, the defect identifier 600 may detect the tightening torque between the first nut 200 and the second nut 100 while approaching the reference number of turns between the battery bolt 300 and the first nut 200, and check a defect in the first nut 200 or the second nut 100 or identify that the first nut 200 or the second nut 100 is defective when the decrease in the tightening torque due to loosening between the first nut 200 and the second nut 100 is detected before reaching the reference tightening torque between the battery bolt 300 and the first nut 200.

Furthermore, the defect identifier 600 may identify that the battery bolt 300 or the first nut 200 are defective when the tightening torque between the battery bolt 300 and the first nut 200 exceeds the reference tightening torque as the battery bolt 300 or the internal screw thread B of the first nut 200 is worn out or damaged, and the tightening torque is suddenly decreased as the first nut 200 and the second nut 100 are loosened.

When the internal screw thread B of the first nut 200 is worn out or damaged due to repeated attachment/detachment of the battery pack, the tightening torque between the battery bolt 300 and the first nut 200 may be provided exceeding the reference tightening torque. Furthermore, under the condition that the tightening torque between the battery bolt 300 and the first nut 200 exceeds the reference tightening torque, the direction in which the battery bolt 300 is tightened to the first nut 200 is the same as the direction in which the first nut 200 and the second nut 100 are loosened, and therefore the first nut 200 and the second nut 100 may be loosened by excessively provided torque. Therefore, when it is detected that the tightening torque between the battery bolt 300 and the first nut 200 exceeds the reference tightening torque, the defect identifier 600 detects a tightening torque between the first nut 200 and the second nut 100, checking the battery bolt 300 or the first nut 200 or diagnosing the battery bolt 300 or the first nut 200 with a defect.

Ultimately, the battery pack case of the vehicle according to the present disclosure employs a coupling structure of a bolt and nut without welding a fastening nut to a vehicle body frame, so that maintenance costs may be reduced by replacing only a nut portion with a new one when a battery bolt and the thread of the nut portion are worn out or damaged, and a defect in the bolt or nut portion may be detected in advance by detecting a tightening torque or the number of turns.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle battery pack case comprising:
a battery bolt provided in a lateral side of a vehicle frame;
a first nut provided outside the battery bolt, and including an internal screw thread formed inside the first nut and an external screw thread formed outside the first nut, wherein tightening directions of the internal screw thread and the external screw thread are opposite to each other, and the first nut is tightened to the battery bolt through the internal screw thread; and
a second nut provided outside the battery bolt and the first nut, and tightened to the first nut through the external screw thread formed on the first nut.

2. The vehicle battery pack case of claim 1,
wherein a lower end portion of the battery bolt is vertically supported on the vehicle frame, and is fastened to the first nut in upward and downward directions thereof.

3. The vehicle battery pack case of claim 1,
wherein the first nut includes a groove formed on a bottom portion thereof to fasten or remove the first nut therethrough.

4. The vehicle battery pack case of claim 3,
wherein the second nut is fixed in the vehicle frame when the groove is used in fastening or removing the first nut.

5. The vehicle battery pack case of claim 1,
wherein the internal screw thread of the first nut is one of a right-handed screw or a left-handed screw and the external screw thread of the first nut is another of the right-handed screw or the left-handed screw, and
wherein the thread directions of the internal screw thread and the external screw thread are opposite to each other, and an internal side and an external side of the first nut are respectively bolted to the battery bolt and the second nut.

6. The vehicle battery pack case of claim 1,
wherein a tightening torque between the first nut and the second nut is greater than a tightening torque between the battery bolt and the first nut.

7. The vehicle battery pack case of claim 1,
wherein a lower end portion of the first nut includes a flange extending outwards to support the battery bolt.

8. The vehicle battery pack case of claim 1,
wherein the second nut includes an external diameter longer than an external diameter of the first nut.

9. The vehicle battery pack case of claim 1,
wherein the second nut includes an external diameter longer than an external diameter of the battery bolt.

10. A vehicle battery pack case replacement system comprising:
a battery bolt provided in a lateral side of a vehicle frame;
a first nut provided outside the battery bolt, and including an internal screw thread formed inside the first nut and an external screw thread formed outside the first nut, wherein tightening directions of the internal screw thread and the external screw thread are opposite to each other, and the first nut is tightened to the battery bolt through the internal screw thread;
a second nut provided outside the battery bolt and the first nut, and tightened to the first nut through the external screw thread formed on the first nut; and
a defect identifier configured to detect tightening information including a tightening torque and a number of turns when the battery bolt is tightened to the first nut, and to identify whether the battery bolt and the first nut are defective based on the detected tightening information.

11. The vehicle battery pack case replacement system of claim 10,
wherein the defect identifier identifies that the battery bolt or the first nut is defective when the tightening torque between the battery bolt and the first nut does not reach a reference tightening torque or the number of turns between the battery bolt and the first nut does not reach a reference number of turns.

12. The vehicle battery pack case replacement system of claim 10,
wherein the defect identifier identifies that the battery bolt or the first nut is normal when the tightening torque between the battery bolt and the first nut reaches a reference tightening torque or the number of turns between the battery bolt and the first nut reaches a reference number of turns.

13. The vehicle battery pack case replacement system of claim 10,
wherein the defect identifier identifies that the first nut or the second nut is defective as the first nut and the second nut are loosened when the defect identifier detects that the tightening torque between the battery bolt and the first nut is decreased before the number of turns reaches a reference number of turns.

14. The vehicle battery pack case replacement system of claim 10,
wherein the defect identifier identifies that the battery bolt or the first nut is defective when the tightening torque between the battery bolt and the first nut exceeds a reference tightening torque, and the tightening torque between the first nut and the second nut is decreased.
